(19) United States
(12) Patent Application Publication
(10) Pub. No.: US 2009/0015192 A1
(43) Pub. Date: Jan. 15, 2009

(54) Portable-electric-appliance protector/power supplier

(75) Inventor: Jimm-Ming Sheu, Taipei City (TW)

Correspondence Address: BACON & THOMAS, PLLC, 625 SLATERS LANE, FOURTH FLOOR, ALEXANDRIA, VA, 22314-1176, US

(73) Assignee: Great Performance Industries Co., Ltd, Taipei City (TW)

(21) Appl. No.: 11/822,773

(22) Filed: Jul. 10, 2007

(51) Int. Cl. H02J 7/00

(52) U.S. Cl. 320/103

(57) ABSTRACT

A portable-electric-appliance protecting and electricity supplying device used for charging a portable electric-appliance which can be at the same time received in a leather casing, thus an object of convenient using can be achieved. The device is provided in a receiving housing for receiving a portable electric appliance having a set of electricity supplying module which further comprises: a first connector for insertion connecting with a power input port of the portable electric appliance, and a power supply circuit; wherein the power supply circuit is connected with a storage battery, when the portable electric appliance is received in the receiving housing to connect the first connector, the storage battery supplies electricity for the portable electric appliance through the power supply circuit.

### BACKGROUND OF THE INVENTION

1. Field of the Invention

The present invention is related to a portable-electric-appliance protecting and electricity supplying device, and especially to a conveniently portable protecting and electricity supplying device that can immediately supply electricity for a portable electric-appliance for charging when the portable electric-appliance has insufficient power.

2. Description of the Prior Art

Portable electric appliances available presently, such as PDAs, GPSs, mobile phones, notebooks, pocket PCs, DVs, DC. Etc., not only are given with high attention on their development of new functions and on their features of smallness and beauty, but also are paid much delicate thought on their appearances in order that general portable electric appliances carried on users' own persons with protecting devices such as leather casings, receiving bags etc. can avoid damage of appearance as possible as the protecting devices can help; therefore, the protecting devices such as leather casings, receiving bags etc. nearly are necessary accessories carried on ones own persons outdoors.

And more, general portable electric appliances mainly are provided with charging batteries for charging any time, and by virtue that the portable electric appliances nearly completely rely on the power of batteries, once the appliances are out of electric power, they are unable to normally operate no matter how cool or how marvelous they are.

The largest trouble of batteries is that their sustaining capability is hard to control, for instance: times that their can be charged, environmental temperatures, time for use, ways of charging etc. all can influence the life of the batteries; even when the batteries just charged are loaded in portable electric appliances, no guarantee can be given that the batteries can afford operation completely in all the time of outdoor using of the portable electric appliances.

By the indefiniteness of the time of use of the batteries state above, common consumers mostly carry extra spare batteries on their own persons for the purpose of changing batteries when the batteries carried are out of electric power; however for the consumers, carrying the spare batteries not only adds a burden against the outdoor action capability, but also a trouble that the spare batteries have no place to place in or even that they are subjected to losing is resulted.

Further, the portable electric appliances generally have charging devices, such as the often seen charging devices for traveling and charging devices with charging seats etc. However, these charging devices normally must be used indoors where there are sockets connected with electric power sources; this not only is inconvenient, but also is unable to charge the portable electric appliances outdoors.

### SUMMARY OF THE INVENTION

In view of the above, the main object of the present invention is to provide a conveniently portable protecting and electricity supplying device that can immediately supply electricity for a portable electric appliance for charging when the portable electric-appliance has insufficient power.

To achieve the above object, the present invention is provided in a receiving housing for receiving a portable electric appliance having a set of electricity supplying module; the electricity supplying module further comprises: a first connector for insertion connecting with a power input port of the portable electric appliance, and a power supply circuit; wherein the power supply circuit is connected with a storage battery, when the portable electric appliance is received in the receiving housing to connect the first connector, the storage battery supplies electricity for the portable electric appliance through the power supply circuit.

Particularly, the present invention has the following effects:
1. The portable-electric-appliance protecting and electricity supplying device is convenient for carrying on one's person, and can supply electricity for the portable electric appliance for charging, this solves the problem that a portable electric appliance is unable to be charged outdoors.
2. The portable-electric-appliance protecting and electricity supplying device can simultaneously receives the portable electric appliance and the storage battery, this can save cumbersomeness of further carrying a spare battery.
3. The portable-electric-appliance protecting and electricity supplying device can be added with a control circuit, in order that when the control circuit detects that the portable electric appliance has insufficient electric power, the storage battery can supply electricity for the portable electric appliance through the power supply circuit; and this can effectively reduce damage on the portable electric appliance.
4. When the portable electric appliance is placed in position, by virtue that the first connector makes connecting of the portable electric appliance with the electricity supplying module, the portable-electric-appliance protecting and electricity supplying device can save changing of battery and taking out the battery as well as restarting the portable electric appliance.

The present invention will be apparent in its technical measures after reading the detailed description of the preferred embodiment thereof in reference to the accompanying drawings.

### BRIEF DESCRIPTION OF THE DRAWINGS

FIG. 1 is a schematic perspective view showing insertion and drawing out of the portable electric appliance in the present invention;

FIG. 2 is an anatomic perspective view showing the back side of the present invention;

FIG. 3 is a block diagram showing the structure of the electricity supplying module of the present invention;

FIG. 4 is a schematic perspective view showing another way of insertion and drawing out of the portable electric appliance in the present invention;

FIG. 5 is a schematic perspective view showing the action of pivoting of a first connector of a second embodiment of the present invention.

### DETAILED DESCRIPTION OF THE PREFERRED EMBODIMENT

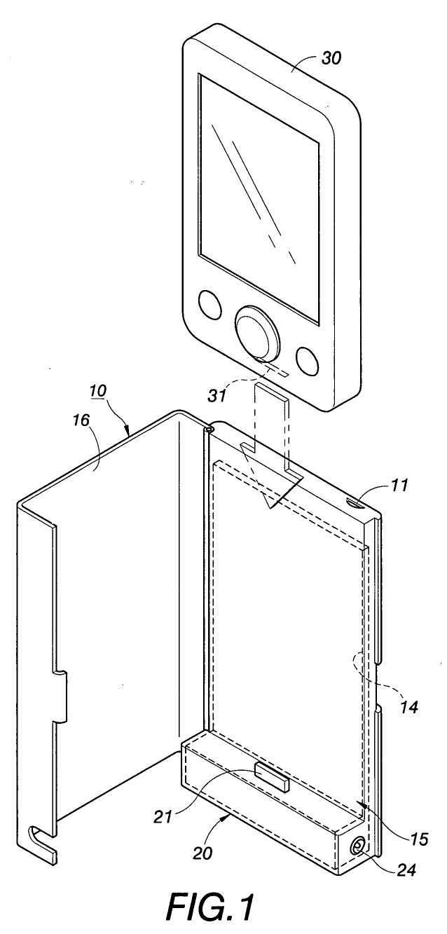

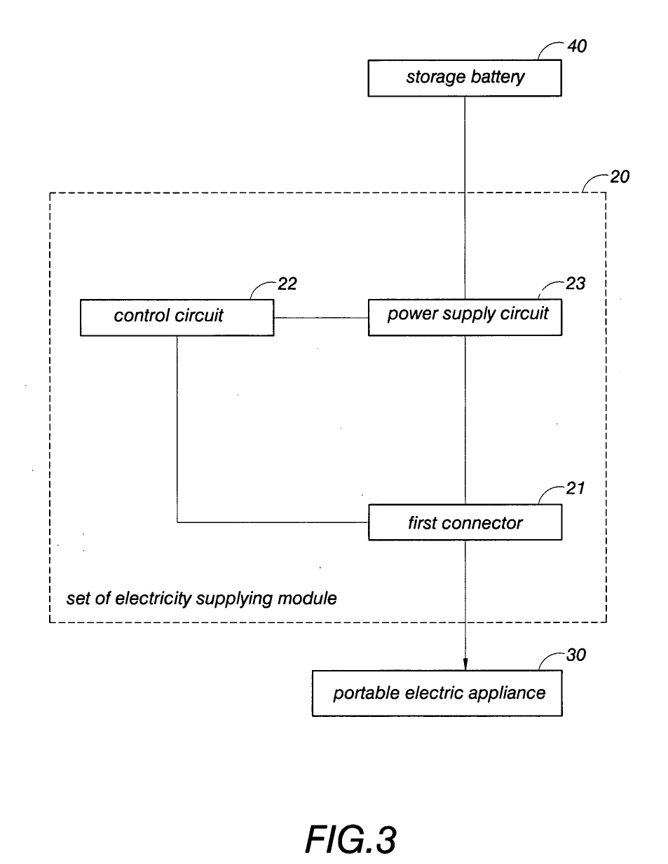

The present invention provides a portable-electric-appliance protecting and electricity supplying device, that can immediately supply electricity for a portable electric-appliance for charging when the portable electric-appliance has insufficient power; referring to FIGS. 1 to 3, the entire portable-electric-appliance protecting and electricity supplying device basically is composed of a receiving housing 10 and a set of electricity supplying module 20 in combination with the receiving housing 10; wherein the receiving housing 10 is used for receiving a portable electric appliance 30; the electricity supplying module 20 further comprises: a first connector 21 for insertion connecting of a power input port 31 of the portable electric appliance 30, a control circuit 22 and a power supply circuit 23.

The power supply circuit 23 in the electricity supplying module 20 is connected with a storage battery 40, when the portable electric appliance 30 is received in the receiving housing 10 to electrically connect the first connector 21, by insertion connecting of the first connector 21 with the power input port 31, the portable electric appliance 30 is electrically connected with the electricity supplying module 20, the storage battery 40 thus supplies electricity for the portable electric appliance 30 through the power supply circuit 23.

The portable electric appliance 30 used in the present invention is selected from at least: a PDA, a GPS, a notebook, a pocket PC, a DV, a DC etc., the receiving housing 10 is a protecting sheath with a shape in corresponding with and able to receive the portable electric appliance 30, the material of the protecting sheath can be selected from one or more of the followings: leather, plastic, metal; and in practicing, the receiving housing 10 in the shape of the protecting sheath can be provided with a loop 11 for being hung or tied with a rope, or it is provided on its back with a back clip 13 for a user to clamp it on something (such as a waistband) worn on his person for use outdoors; and more, some receiving housing 10 is provided directly with a back belt for a user to hang on his shoulder.

The receiving housing 10 further has a receiving space 14 for receiving the electricity supplying module 20, and a positioning space 15 for firmly holding the portable electric appliance 30. And the first connector 21 in the electricity supplying module 20 protrudes outwardly into the positioning space 15, in order that the first connector 21 can be insertion connected with the power input port 31 when the portable electric appliance 30 is inserted into the receiving housing 10, thereby the portable electric appliance 30 can be electrically connected with the electricity supplying module 20. Under operation of the electricity supplying module 20, when the portable electric appliance 30 has insufficient power, it needs not to take out the storage battery 40, rather, the storage battery 40 can be charged via the power supply circuit 23 for supplying power for the portable electric appliance 30; this can save the cumbersomeness of taking out the storage battery 40 for changing it for a spare battery and restarting the electric appliance 30.

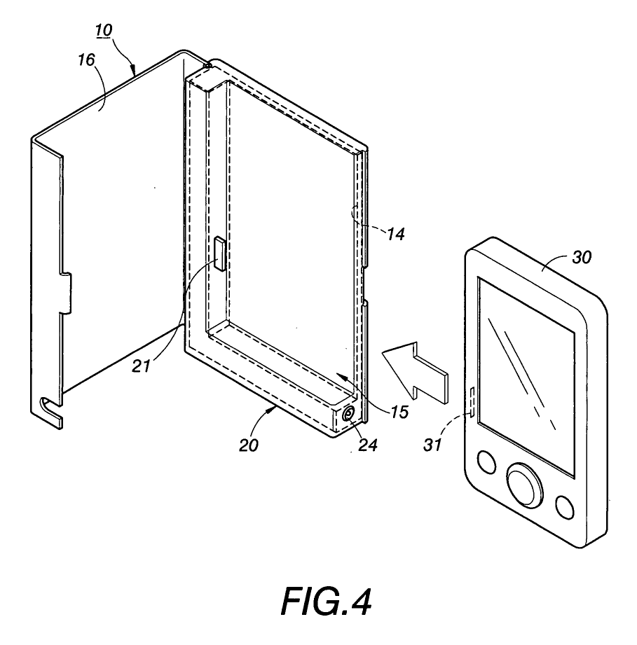

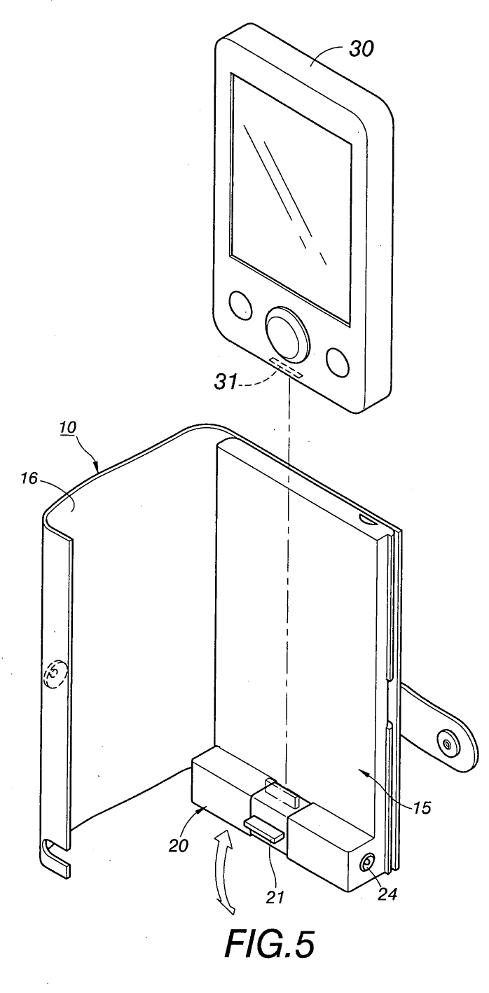

As shown in FIG. 4, the receiving housing 10 can also be provided in the positioning space 15 with a liftable cover 16 in favor of putting in/taking out of the portable electric appliance 30 vertically or horizontally relative to the receiving housing 10. Surely, the first connector 21 can be provided on a side surface or at a bottom spot in the positioning space 15 in cooperation with the power input port 31 in the direction of insertion/drawing out of the portable electric appliance 30. When in practicing, as is shown in FIG. 5, the first connector 21 can be designed to be a pivotal structure to increase the convenience of insertion/drawing out of the portable electric appliance 30.

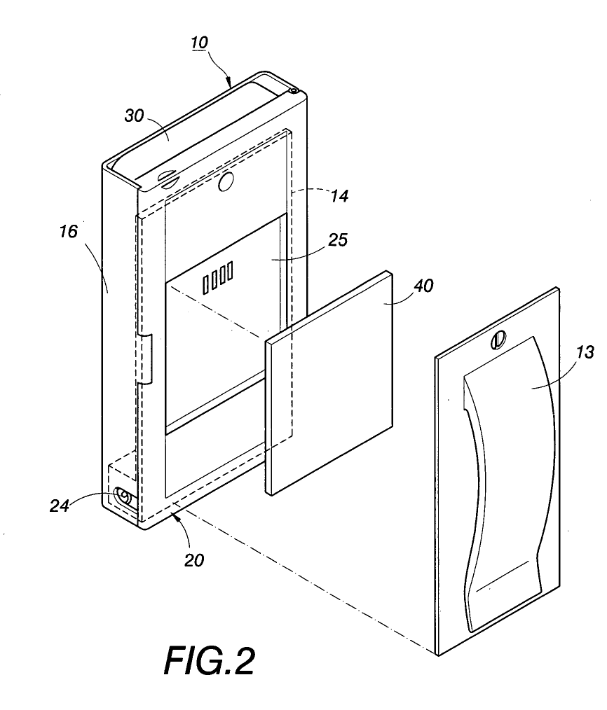

As shown in FIGS. 1 and 2, by virtue that the portable-electric-appliance protecting and electricity supplying device can receive the portable electric appliance 30 and the storage battery 40 simultaneously, the cumbersomeness of carrying another spare battery can be saved; this effectively eliminate the problem of inability of charging outdoors. And the storage battery 40 to supply electricity for the portable electric appliance 30 can be a chargeable battery built in the receiving housing 10, or can be a discardable battery that can be placed in the receiving housing 10.

When the storage battery 40 is a chargeable battery, the electricity supplying module 20 can further be provided with a second connector 24 connectable with an outer electric power source to charge the storage battery 40; and when the storage battery 40 is a discardable battery, the electricity supplying module 20 can be provided with a battery receiving groove 25 at a corresponding area in the receiving housing 10 in favor of changing of the storage battery 40; surely, the electricity supplying module 20 can be provided simultaneously with the second connector 24 and the battery receiving groove 25, when the battery receiving groove 25 is received therein with the common changeable and chargeable storage battery 40, it can charge the storage battery 40 to increase the applicability and convenience of the portable-electric-appliance protecting and electricity supplying device.

With the above stated designed structure, the problem of inability of charging outdoors can be solved; this can save the cumbersomeness of taking out the storage battery 40 for changing it for a spare battery and restarting the electric appliance 30, and this can reduce damage on the portable electric appliance.

While the description and the drawings given are only for illustrating the embodiment of the present invention, and not for giving any limitation to the scope of the present invention; it will be apparent to those skilled in this art that various equivalent modifications or changes without departing from the spirit of this invention shall also fall within the scope of the appended claims.

1. A portable-electric-appliance protecting and electricity supplying device comprising a receiving housing and a set of electricity supplying module, wherein:
said receiving housing is used for receiving a portable electric appliance; said electricity supplying module is in combination with said receiving housing and further comprises: a first connector for insertion connecting of a power input port of said portable electric appliance, a power supply circuit for charging said portable electric appliance with electrically from a storage battery supplying electricity, and a second connector connected with an outer electric power source to charge said storage battery.

2. The portable-electric-appliance protecting and electricity supplying device as in claim 1, wherein: said electricity supplying module further is provided with a battery receiving groove for changing of said storage battery.

3. The portable-electric-appliance protecting and electricity supplying device as in claim 1, wherein: said portable electric appliance is selected from at least: a PDA, a GPS, a notebook, a pocket PC, a DV, a DC etc., said receiving housing is a protecting sheath with a shape in corresponding with said portable electric appliance and adapted to receiving said portable electric appliance.

4. The portable-electric-appliance protecting and electricity supplying device as in claim 1, wherein: material of said receiving housing is selected from one or more of: leather, plastic, metal.

5. The portable-electric-appliance protecting and electricity supplying device as in claim 1, wherein: said receiving housing is provided on its back with a back clip for a user to clamp it on a thing worn on his person.

6. The portable-electric-appliance protecting and electricity supplying device as in claim 1, wherein: said receiving housing is provided with a back belt for a user to hang on his person.

7. The portable-electric-appliance protecting and electricity supplying device as in claim 1, wherein: said receiving housing is provided further with a receiving space for receiving said electricity supplying module, and a positioning space for firmly holding said portable electric appliance; said first connector in said electricity supplying module protrudes outwardly into said positioning space, in order that said first connector is adapted to insertion connecting with said power input port of said portable electric appliance.

8. The portable-electric-appliance protecting and electricity supplying device as in claim 7, wherein: said receiving housing is provided in said positioning space with a liftable cover.

9. The portable-electric-appliance protecting and electricity supplying device as in claim 1, wherein: said first connector is a pivotal structure.

10. The portable-electric-appliance protecting and electricity supplying device as in claim 1, wherein: said electricity supplying module is provided further with a control circuit in order that when said control circuit detects that said portable electric appliance has insufficient electric power, said storage battery charges said portable electric appliance.

11. A portable-electric-appliance protecting and electricity supplying device comprising a receiving housing and a set of electricity supplying module, wherein:
said receiving housing is used for receiving a portable electric appliance; said electricity supplying module is in combination with said receiving housing and further comprises: a first connector and a power supply circuit, said electricity supplying module further is provided with a battery receiving groove for receiving a storage battery, when said first connector is insertion connected with a power supply circuit, said storage battery supplies electricity for said portable electric appliance.

12. The portable-electric-appliance protecting and electricity supplying device as in claim 11, wherein: said storage battery is a chargeable battery, said electricity supplying module further is provided with a second connector connecting with an outer electric power source to charge said storage battery.

13. The portable-electric-appliance protecting and electricity supplying device as in claim 11, wherein: said storage battery is a discardable battery.

14. The portable-electric-appliance protecting and electricity supplying device as in claim 11, wherein: said portable electric appliance is selected from at least: a PDA, a GPS, a notebook, a pocket PC, a DV, a DC etc., said receiving housing is a protecting sheath with a shape in corresponding with said portable electric appliance and adapted to receiving said portable electric appliance.

15. The portable-electric-appliance protecting and electricity supplying device as in claim 11, wherein: material of said receiving housing is selected from one or more of: leather, plastic, metal.

16. The portable-electric-appliance protecting and electricity supplying device as in claim 11, wherein: said receiving housing is provided on its back with a back clip for a user to clamp it on a thing worn on his person.

17. The portable-electric-appliance protecting and electricity supplying device as in claim 11, wherein: said receiving housing is provided further with a receiving space for receiving said electricity supplying module, and a positioning space for firmly holding said portable electric appliance; said first connector in said electricity supplying module protrudes outwardly into said positioning space, in order that said first connector is adapted to insertion connecting with said power input port of said portable electric appliance.

18. The portable-electric-appliance protecting and electricity supplying device as in claim 17, wherein: said receiving housing is provided in said positioning space with a liftable cover.

19. The portable-electric-appliance protecting and electricity supplying device as in claim 11, wherein: said first connector is a pivotal structure.

20. The portable-electric-appliance protecting and electricity supplying device as in claim 11, wherein: said electricity supplying module is provided further with a control circuit in order that when said control circuit detects that said portable electric appliance has insufficient electric power, said storage battery charges said portable electric appliance.
